(19) United States
(12) Patent Application Publication
(10) Pub. No.: US 2014/0212037 A1
(43) Pub. Date: Jul. 31, 2014

(54) IMAGE PROCESSING APPARATUS, IMAGE PROCESSING METHOD, AND COMPUTER READABLE MEDIUM

(71) Applicant: FUJI XEROX CO., LTD., Tokyo (JP)

(72) Inventor: Makoto SASAKI, Kanagawa (JP)

(73) Assignee: FUJI XEROX CO., LTD., Tokyo (JP)

(21) Appl. No.: 14/010,106

(22) Filed: Aug. 26, 2013

(30) Foreign Application Priority Data
Jan. 30, 2013 (JP) 2013-016176

(51) Int. Cl. G06T 7/40

(52) U.S. Cl. CPC G06T 7/408
USPC 382/167

(57) ABSTRACT

An image processing apparatus includes a separating unit, an analyzing unit, a determining unit, and an image correcting unit. The separating unit separates a color image into a foreground image and a background image. The analyzing unit analyzes the foreground image and the background image to acquire a foreground attribute value and a background attribute value. The determining unit determines an image processing coefficient, based on the foreground attribute value and the background attribute value. The image correcting unit corrects the color image, in accordance with the image processing coefficient.

### CROSS-REFERENCE TO RELATED APPLICATIONS

This application is based on and claims priority under 35 USC 119 from Japanese Patent Application No. 2013-016176 filed Jan. 30, 2013.

### BACKGROUND

1. Technical Field

The present invention relates to an image processing apparatus, an image processing method, and a computer readable medium.

2. Related Art

Various types of correction processing have been performed for color images. For example, various types of processing, such as brightening a generally dark image, lightening and smoothing only the skin color of a person, blurring the background not including people to provide perspective, and improving the texture of articles, have been performed as correction processing. In the case where a color image is acquired by a reading device or an imaging device, correction of image quality caused by a variation in the performance among devices may be included in correction processing. Although depending on the request, purpose, usage, or the like, images are corrected using software or a device in any cases. Various types of software and devices for performing image correction have been available.

As the technology of correction advances, more advanced skills and know-hows are required for correction of images. General users tend to desire automatic correction, and correction processing may be realized by only a button-pressing operation. In contrast, professional designers tend not to desire automatic correction. They achieve a satisfactory image quality by using multiple functions through manual operations and utilizing their know-how and skills.

In terms of the processing capacity of an apparatus, image correction has been performed by personal computers (hereinafter, referred to as a PC). Due to the widespread of laptops, some designers perform image correction outside their home or office. In contrast, a technology called information and communication technology (ICT) has become developed. Typical examples of apparatuses used for ICT include tablets. Since tablets adopt direct rendering using a finger or a pen, compared to a retouch operation using a mouse, the direct rendering allows a user to feel as if he/she performed an operation directly on paper. Not a small number of illustrators and retouchers perform correction using a tablet. With the use of such an apparatus, an easier and more direct correction operation has been demanded.

As described above, various types of image correction processing have been available. Correction processing performed for a color image varies depending on the purpose or the like. For example, depending on the purpose or usage, “brightening a principal object without erasing the background against the sun” or “replacing the background with a different one” is performed for a color image. Since the purpose of correction processing is not automatically predicted, a user is at least required to issue an instruction.

Correction processing may be uniformly performed for the entire image. In contrast, correction processing may be performed for a specified specific region. As described above, various types of correction processing including processing for “brightening a principal object without erasing the background against the sun”, processing for “replacing the background with a different one”, “blurring the background to make a principal object conspicuous” and “changing the color of the background” have been available.

### SUMMARY

According to an aspect of the invention, there is provided an image processing apparatus including a separating unit, an analyzing unit, a determining unit, and an image correcting unit. The separating unit separates a color image into a foreground image and a background image. The analyzing unit analyzes the foreground image and the background image to acquire a foreground attribute value and a background attribute value. The determining unit determines an image processing coefficient, based on the foreground attribute value and the background attribute value. The image correcting unit corrects the color image, in accordance with the image processing coefficient.

### BRIEF DESCRIPTION OF THE DRAWINGS

Exemplary embodiments of the present invention will be described in detail based on the following figures, wherein:

FIG. 1 is a block diagram illustrating a first exemplary embodiment of the present invention;

FIGS. 2A, 2B, and 2C are explanatory diagrams illustrating an example of a screen for receiving prior information;

FIG. 3 is an explanation diagram illustrating another example of the screen for receiving prior information;

FIG. 4 is an explanatory diagram illustrating another example of the screen for receiving prior information;

FIG. 5 is an explanatory diagram illustrating the overview of a separation method for an image using graph linkage;

FIGS. 6A and 6B are explanatory diagrams illustrating an example of separated images;

FIGS. 7A and 7B are explanatory diagrams illustrating examples of a foreground attribute value and a background attribute value;

FIG. 8 is an explanatory diagram illustrating an example of a DOG function;

FIG. 9 is an explanatory diagram illustrating an example of the relationship between a control coefficient of a DOG function and characteristics;

FIG. 10 is an explanatory diagram illustrating an example of an image resolved according to band;

FIG. 11 is a block diagram illustrating a variation of the first exemplary embodiment of the present invention;

FIGS. 12A and 12B are explanatory diagrams illustrating examples of presenting options by a correction candidate presenting unit;

FIG. 13 is a block diagram illustrating a second exemplary embodiment of the present invention;

FIG. 14 is an explanatory diagram illustrating an example of processing performed in the second exemplary embodiment of the invention;

FIGS. 15A and 15B are explanatory diagrams illustrating another example of the processing performed in the second exemplary embodiment of the invention;

FIGS. 16A and 16B are explanatory diagrams illustrating another example of the processing performed in the second exemplary embodiment of the invention;

FIG. 17 is a block diagram illustrating a first variation of the second exemplary embodiment of the invention;

FIG. 18 is an explanatory diagram illustrating an example of processing performed by an image correcting unit using a weighted image;

FIG. 19 is a block diagram illustrating another variation of the second exemplary embodiment of the invention;

FIGS. 20A, 20B, 20C, 20D, and 20E are explanatory diagrams illustrating an example of separation processing performed plural times;

FIG. 21 is an explanatory diagram illustrating an example of a screen presented to a user in the case where plural foreground images are separated from the original image;

FIGS. 22A and 22B are explanatory diagrams illustrating examples of options presented by a correction candidate presenting unit in a second variation of the second exemplary embodiment of the invention;

FIG. 23 is an explanatory diagram illustrating an example of processing performed by an image correcting unit in the second variation of the second exemplary embodiment of the invention; and

FIG. 24 is an explanatory diagram illustrating an example of a computer program and a storage medium and a computer in which the computer program is stored in the case where functions explained in the exemplary embodiments and the variations of the present invention are implemented by the computer program.

### DETAILED DESCRIPTION

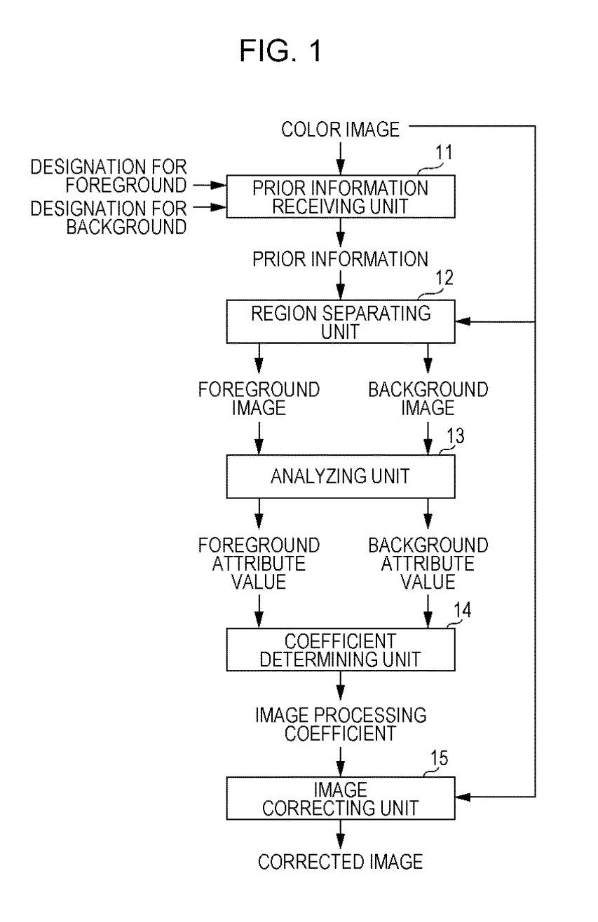

FIG. 1 is a block diagram illustrating a first exemplary embodiment of the present invention. Referring to FIG. 1, a prior information receiving unit 11, a region separating unit 12, an analyzing unit 13, a coefficient determining unit 14, and an image correcting unit 15 are provided.

The prior information receiving unit 11 receives from a user prior information for designating the foreground and background of a color image. A designation for the foreground or background may be received, as a collection of dots or lines, using a pointing device, such as a mouse or a digitizer, in the case of a personal computer (PC) or using a pen or a finger in the case of an ICT device, such as a tablet. The prior information receiving unit 11 is not necessarily provided.

The region separating unit 12 separates a color image into a foreground image and a background image. In the case where the prior information receiving unit 11 is not provided, well-known region separation processing may be performed. In the case where the prior information receiving unit 11 is provided, a color image is separated into a foreground image and a background image on the basis of prior information received by the prior information receiving unit 11.

A separation method using graph linkage is an example of separation processing using prior information. A color image may be separated into a foreground and a background by performing graph linking for pixels to generate graph link information on the basis of a color image and prior information and cutting off links in accordance with the maximum flow-minimum cut theorem on the basis of the graph link information. With the maximum flow-minimum cut theorem, in the case where water is caused to flow from a start point, which is a virtual node of a foreground, to an end point, which is a virtual node of a background, the maximum amount of water that is capable of being flowed is calculated. The maximum flow-minimum cut theorem is a principle that, on the assumption that the value of a link is regarded as the width of a water pipe, the total sum of cut-off bottleneck portions (water is difficult to flow) is equal to the maximum flow amount. That is, cutting off a link serving as a bottleneck causes a foreground and a background to be separated from each other (graph cut). Obviously, a method for separating between a foreground image and a background image is not limited to the method mentioned above.

The analyzing unit 13 individually analyzes a foreground image and a background image that are separated from each other by the region separating unit 12 to acquire a foreground attribute value and a background attribute value. As a foreground attribute value and a background attribute value, at least one of the average of color pixels, the variance of color pixels, the histogram of color pixels, the average of image frequencies, the variance of image frequencies, and the histogram of image frequencies may be analyzed. The average, variance, and histogram of color pixels may be analyzed on the basis of the brightness and color. The color may be analyzed on the basis of any value, such as an RGB value, an sRGB value, a CMYK value, an L*a*b* value, or a YCrCb value, as long as the value is a scale representing color.

The coefficient determining unit 14 determines an image processing coefficient on the basis of a foreground attribute value and a background attribute value acquired by the analyzing unit 13. In the first exemplary embodiment, since correction processing is performed for the entire given color image, the coefficient determining unit 14 determines an image processing coefficient for the entire image. An image processing coefficient is determined on the basis of the relationship between a foreground attribute value and a background attribute value.

The image correcting unit 15 performs correction processing for a given color image, on the basis of an image processing coefficient determined by the coefficient determining unit 14. The image correcting unit 15 performs correction processing on the basis of an image processing coefficient determined by the coefficient determining unit 14 on the basis of a foreground attribute value and a background attribute value, and processing corresponding to the details of the foreground and the background is performed. Correction processing may include at least one of color correction and frequency correction. For example, color correction processing may be processing using a tone curve of brightness or color saturation, histogram equalization, or gradation correction. Furthermore, a method described in Japanese Unexamined Patent Application Publication No. 2006-135628, which is a method for forming a three-dimensional object representing an adjustment range inside a color space and correcting color within the range of the three-dimensional object, may be used. Although the background as well as the foreground is corrected even when a color region is limited by the method mentioned in Japanese Unexamined Patent Application Publication No. 2006-135628, correction processing that achieves the balance between the foreground and the background is performed by performing correction processing on the basis of an image processing coefficient determined by the coefficient determining unit 14.

The configuration described above will be explained in further detail by way of a specific example. In the example explained below, the case where the region separating unit 12 separates a color image into a foreground image and a background image by a separation method using graph linkage will be explained as an example.

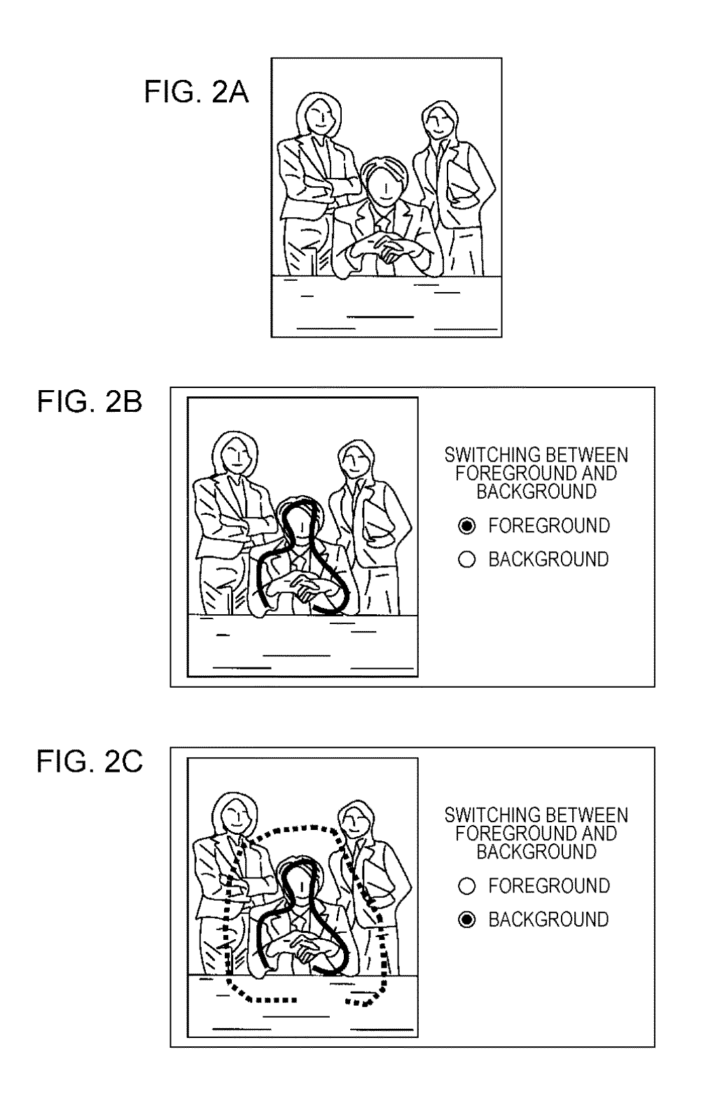

First, the prior information receiving unit 11 receives from a user prior information for designating the foreground and background of a color image. FIGS. 2A, 2B, and 2C are explanatory diagrams illustrating an example of a screen for receiving prior information. FIG. 2A illustrates an example of a color image to be processed. The color image to be processed is presented to a user, and a designation for a region to be defined as a foreground of the image and a designation for a region to be defined as a background of the image are received. FIGS. 2B and 2C illustrate examples of designations. FIG. 2B illustrates an example in which a designation for the foreground is performed. FIG. 2C illustrates an example in which a designation for the background is performed after the designation for the foreground is performed. The designation for the foreground is represented by a thick line, and the designation for the background is represented by a broken line. Switching between the foreground and the background may be performed using a radio button illustrated as “switching between foreground and background”. The above-mentioned designations may be performed using a pointing device, such as a mouse or a digitizer, in the case of a PC or using a pen or a finger in the case of an ICT device, such as a tablet.

Although depending on the separation processing by the region separating unit 12, in the case of a separation method using graph linkage, a method for designating a foreground or a background may be received as a collection of dots or lines, and the profile is not necessarily accurately specified. In the example illustrated in FIGS. 2A to 2C, as a designation for a foreground, a portion inside the region of the central person is specified by a line. Furthermore, as a designation for a background, a portion outside the region of the central person is specified by a line. For example, in the case where a person is designated for a foreground, the hair, skin, clothing, and the like of the person may be partially specified. In the case where a person to be designated for a foreground holds his or her belongings and the belongings are also to be designated for the foreground, the belongings are partially specified as foreground information. A region that is not designated for the foreground and that is not desired to be designated for the foreground may be partially specified. In the example illustrated in FIGS. 2A to 2C, right and left people, the desk, the wall, and the like may be partially specified.

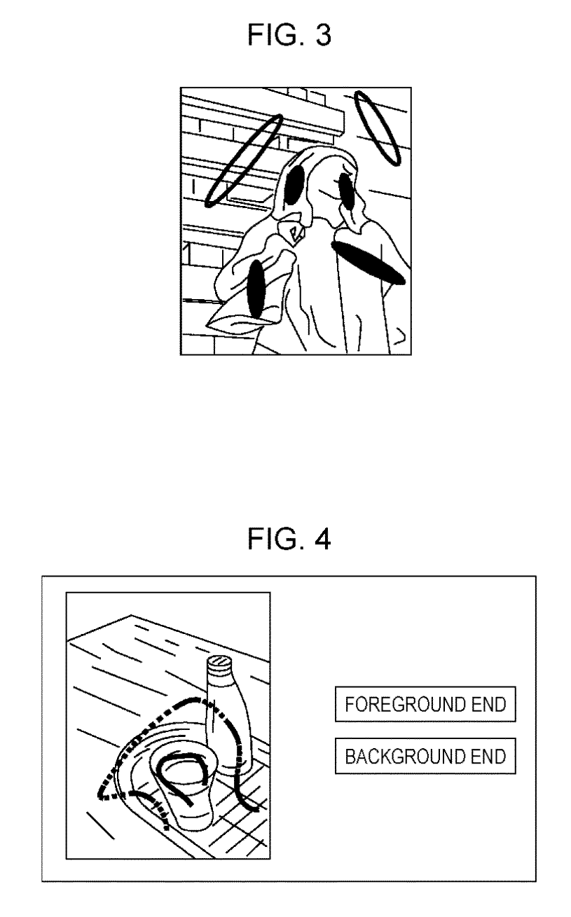

FIG. 3 is an explanatory diagram illustrating another example of the screen for receiving prior information. In FIGS. 2A to 2C, each of the designations for the foreground and the background is provided by a single line. However, in the example illustrated in FIG. 3, each of the designations for the foreground and the background is provided by plural lines or dots. In this example, designations for the foreground are provided by black ovals, and designations for the background are provided by white ovals. In this example, the hair, face, clothing, bag, and the like of a person are designated for the foreground, and some portions of a building are designated for the background. As described above, plural designations may be performed for the foreground, and plural designations may be performed for the background.

FIG. 4 is an explanatory diagram illustrating another example of the screen for receiving prior information. In the example illustrated in FIG. 4, an image including an article is illustrated. An interested region, which is not necessarily a person, may be designated for a foreground, and a region that is not desired to be included in the foreground may be designated for a background. In the example illustrated in FIG. 4, a glass is designated for the foreground, and other regions are designated for the background.

Referring to FIG. 4, instead of a radio button, a “foreground end” button and a “background end” button are provided. First, a designation for a foreground is issued. After the issuance of the designation for the foreground is completed, the “foreground end” button is operated. Then, a designation for a background is issued. After the issuance of the designation for the background is completed, the “background end” button is operated. Accordingly, the designation operation is terminated.

Apart from the designation methods described above, a designation method without using the buttons mentioned above may be performed. An operation from the start to termination of the first touch may be defined as a designation for a foreground. After the termination of the first touch, switching between designation for a foreground and designation for a background may be performed. Then, an operation from the start to termination of the second touch may be defined as a designation for a background.

Although the methods for designating prior information have been described above, the configuration of the screen, a designation method, a method for switching between designation for a foreground and designation for a background are not limited to the examples described above. Any of various screen configurations, various designation methods, and various switching methods may be selected and used.

Prior information received at the prior information receiving unit 11 is sent to the region separating unit 12. In this example, the region separating unit 12 separates a color image into a foreground image and a background image on the basis of the prior information in accordance with a separation method using graph linkage. The separation method is described in some documents including, for example, Japanese Unexamined Patent Application Publication No. 2012-027755. Only the overview of the separation method will be explained below.

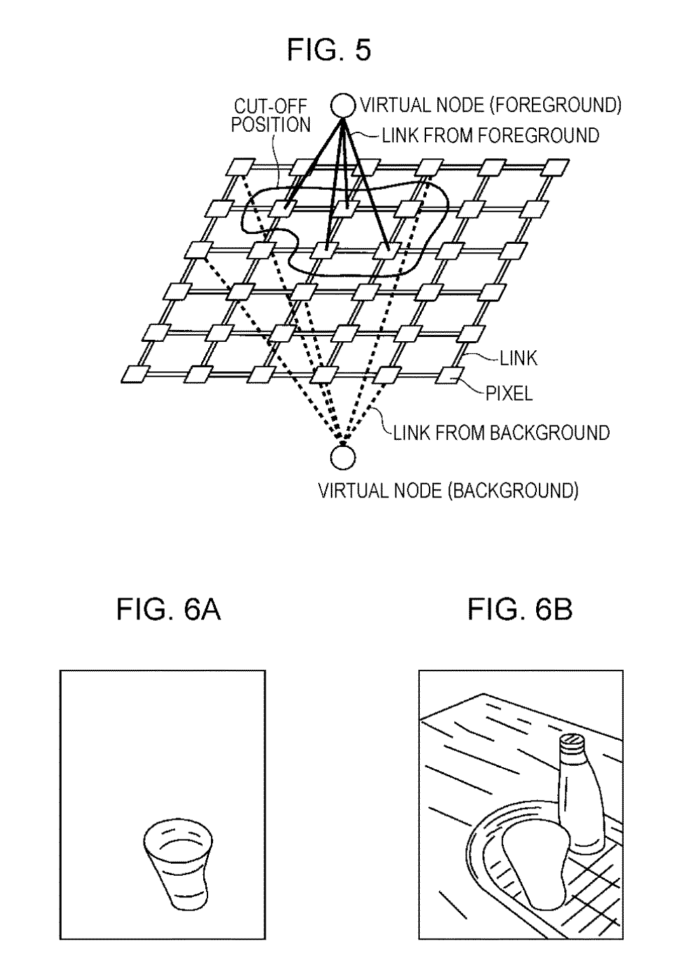

FIG. 5 is an explanatory diagram of the overview of a separation method for an image using graph linkage. Rectangles represent pixels of a color image and are defined as nodes. Furthermore, pixels that are adjacent to each other are regarded as being linked together (represented by double lines). In the case where a specific pixel is compared with a pixel that is adjacent to the specific pixel, a greater value is assigned to the link between the pixels as the similarity between the colors of the pixels increases, and a smaller value is assigned to the link as the similarity between the colors of the pixels decreases.

Furthermore, a foreground virtual node and a background virtual node are provided. Regarding the link from the foreground virtual node to each pixel, “1” is assigned when the pixel is designated for the foreground, and “0” is assigned for the other pixels. In addition, regarding the link from the background virtual node to each pixel, “1” is assigned when the pixel is designated for the background, and “0” is assigned for the other pixels. Practically, pixels designated for the foreground in prior information are linked with the foreground virtual node (represented by thick lines), and pixels designated for the background in prior information are linked with the background virtual node (represented by broken lines). Accordingly, graph linkage is generated.

With such graph linkage, separation is performed using the maximum flow-minimum cut theorem. In this theorem, by defining the foreground virtual node as a start point and defining the background virtual node as an end point, the maximum amount of water that is capable of being flowed from the start point to the end point is calculated on the assumption that the value of each link represents the width of a water pipe. Thus, the total sum of links through which water is hard to flow due to a bottleneck represents the maximum flow amount. By cutting off such links, separation between the foreground and the background is achieved.

FIGS. 6A and 6B are explanatory diagrams illustrating an example of an image for which separation is performed. For example, in the case where designations for the foreground and the background are performed for the color image illustrated in FIG. 4, the region of a glass is separated as a foreground image from the color image, as illustrated in FIG. 6A, and the other region is separated as a background image from the color image, as illustrated in FIG. 6B. In a separation method using graph linkage, by performing designations for the foreground and the background by the simple operation illustrated in FIG. 4, separation between the foreground and the background is accurately performed based on profiles, as illustrated in FIGS. 6A and 6B, even without accurately designating the outline.

Although the case where separation between a foreground image and a background image is performed in accordance with a separation method using graph linkage has been described above, it is obvious that a method for separating between a foreground image and a background image is not necessarily performed in the method described above.

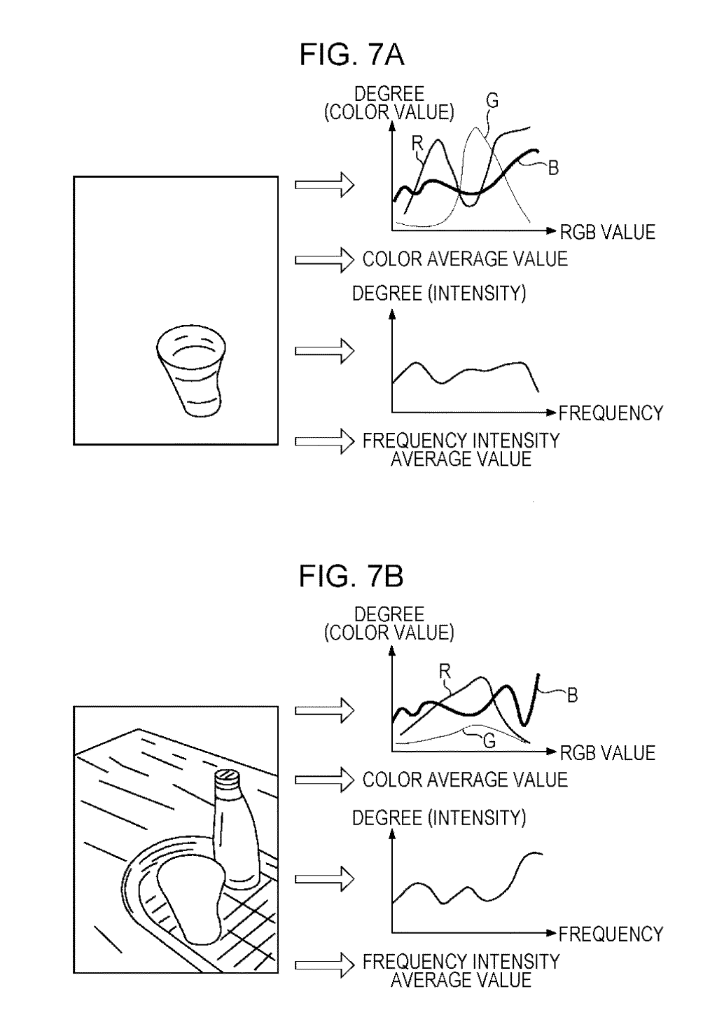

The foreground image and the background image that are separated from each other by the region separating unit 12 are transferred to the analyzing unit 13. The analyzing unit 13 individually analyzes the foreground image and the background image, which are separated from each other by the region separating unit 12, and acquires a foreground attribute value and a background attribute value. FIGS. 7A and 7B are explanatory diagrams illustrating an example of a background attribute value and a background attribute value. In this example, each of the foreground image and the background image illustrated in FIGS. 6A and 6B is analyzed on the basis of a color histogram and the color average, and a frequency histogram and the frequency intensity average, as analysis items. The above-mentioned analysis items serve as a foreground attribute value and a background attribute value.

In the color histogram in this example, RGB values are used as pixel values, and the frequency distribution of each component is acquired. Obviously, for color signals in a different color space, the frequency distribution of each component may be acquired. Furthermore, by acquiring frequency values in various multidimensional color spaces or the like, color histograms may be acquired in various forms.

Regarding frequency analysis, by generating an image for each band for a foreground image or a background image and calculating the intensity average, a frequency intensity histogram is calculated. Furthermore, with the use of the frequency intensity in each band, the average or variance may be calculated. In the above-mentioned frequency analysis for an image, in the case where, for example, the image is in an RGB color space, by converting pixel values from the RGB color space to a color space having luminance components, such as a YCbCr color space or an L*a*b* color space, frequency resolution for each band may be performed using a Y component or an L* component, which is a luminance component.

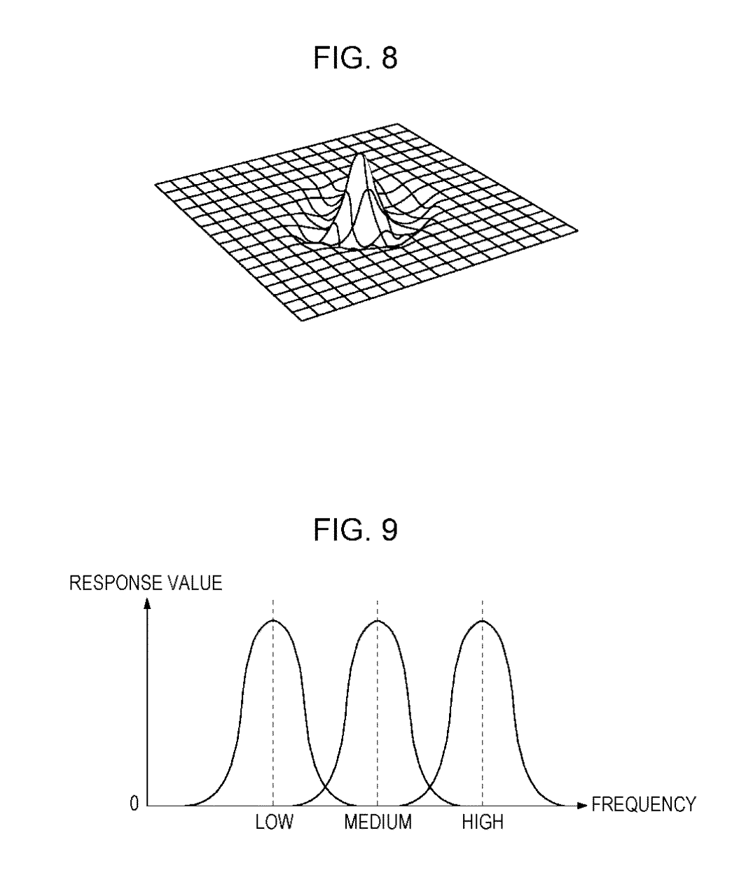

Among various methods of resolution for each band, a method using a difference of two Gaussian (DOG) function as a filter will be described below. FIG. 8 is an explanatory diagram illustrating an example of a DOG function. A DOG function is represented by Equation 1:

G_{DOG}(x,y)=1/2πσₑ²)e^{te}−A·(1/2πσᵢ²)e^{ti} (1),

te=−(x²+y²)/2σₑ²

ti=−x²+y²)/2σᵢ²,

where “σₑ”, “σᵢ”, and “A” represent control coefficients.

The DOG function is known as a mathematical model of visual characteristics in the human brain, and FIG. 8 illustrates an example of the form of the DOG function. By changing a control coefficient, a frequency band, the intensity of the response to the frequency band, and the like are controlled. By adjusting the control coefficient and filtering a luminance component image on the basis of the function represented as Equation 1, a band image corresponding to the set coefficients is obtained. Plural band images may be generated by controlling the control coefficients. Filtering may be performed in a real space or a frequency space. In the case where filtering is performed in a frequency space, an expression obtained by performing Fourier transform on Equation 1 may be used.

FIG. 9 is an explanatory diagram illustrating an example of the relationship between the control coefficients of the DOG function and characteristics. FIG. 9 illustrates frequency bands which are changed by controlling the control coefficients σₑ, σᵢ, and A in Equation 1. A response value on the vertical axis represents a value of the response by a luminance component image to filtering. The greater the response value, the higher the intensity of the response to a frequency band. As illustrated in FIG. 9, by controlling the control coefficients in Equation 1 to change a frequency band and performing filtering, a band image in each frequency band may be obtained.

A Gaussian function may be used for a method of resolution for each band. In this case, Equation 2 may be used:

G(x,y)=(1/2πσ²)·exp(−(x²+y²)/2σ²) (2).

Due to a two-dimensional image, the profile is represented by (x,y). In Equation 2, “σ” represents a coefficient for controlling a band. A lower frequency band is included as the value of “σ” increases. When the value of “σ” decreases, the image is slightly blurred. Thus, a difference from the original image represents a high-frequency component. A medium frequency may be specified on the basis of a difference between images blurred by a first value of “σ” and a second value of “σ” that is smaller than the first value. The difference between the first value of “σ” and the second value of “σ” represents an image of a band between the first value of “σ” and the second value of “σ”. Accordingly, an image whose band is controlled is obtained. As described above, by obtaining a difference between before and after blurring while causing an image to be blurred using the Gaussian function of Equation 2 (generating a low-frequency image), the band may be limited.

Furthermore, in order to perform resolution for each band, an image may be reduced or enlarged. By reducing an image and then enlarging the image, a blurred image is obtained. In this case, the reduction ratio of an image is equivalent to controlling the coefficient σ of the Gaussian function mentioned above. Accordingly, an image whose band is controlled is obtained.

As a method of resolution for each band, a method using the DOG function mentioned above, a method using a Gaussian function, or a method using reduction and enlargement of an image is not necessarily performed. For example, various known methods, such as wavelet transformation, may be used.

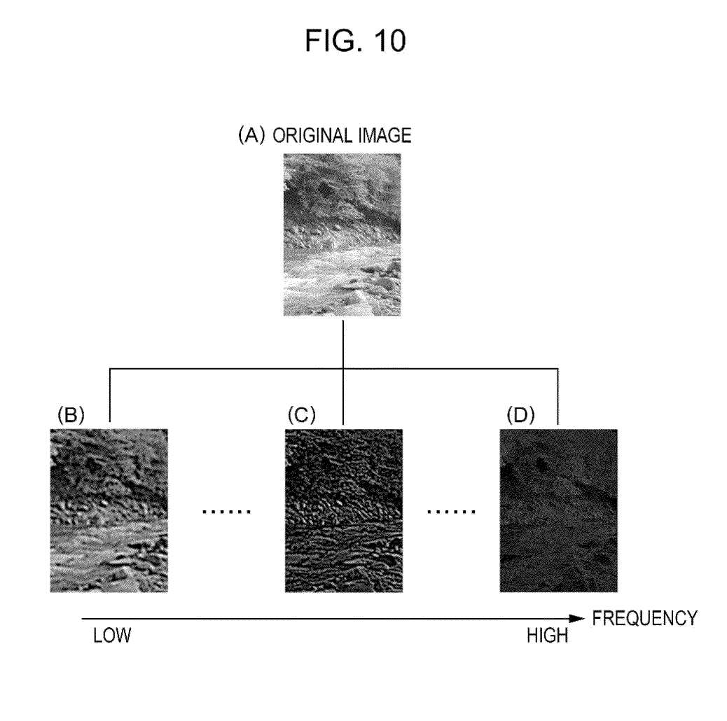

FIG. 10 is an explanatory diagram illustrating an example of images resolved for individual bands. FIG. 10(A) represents luminance components of the original image. In this example, images resolved for individual bands by the various methods mentioned above (hereinafter, referred to as band images) are illustrated in FIGS. 10(B), 10(C), and 10(D). By performing resolution into band images for a foreground image and a background image to generate the frequency distribution of pixels for each of the band images, for example, the frequency intensity histograms illustrated in FIGS. 7A and 7B are generated.

The coefficient determining unit 14 determines an image processing coefficient for performing correction processing for the entire color image, on the basis of the relationship between a foreground attribute value and a background attribute value obtained by the analyzing unit 13. For example, in the case where correction processing for adjusting the skin color of a person is performed, when the skin color represented by a foreground attribute value is darker than a target skin color and the background represented by a background attribute value is brighter than a target brightness, correcting the skin color to the target skin color may cause the background to disappear. In this case, the image processing coefficient may be determined so as not to adjust the skin color to the target skin color. Furthermore, for correction of an image including an article, in the case where the intensity of a high-frequency component of the background is higher than that of the article (foreground), a noise component may exist in the background. In this case, the image processing coefficient for enhancing the frequency of the entire image may be set weaker than usual.

The image correcting unit 15 performs correction processing for a given color image, on the basis of an image processing coefficient determined by the coefficient determining unit 14. For example, processing for color correction, processing for frequency correction, and the like are performed in accordance with the image processing coefficient. Since an image processing coefficient corresponding to the foreground and the background is determined by the coefficient determining unit 14, correction processing is performed in such a manner that the balance between the foreground and the background is achieved.

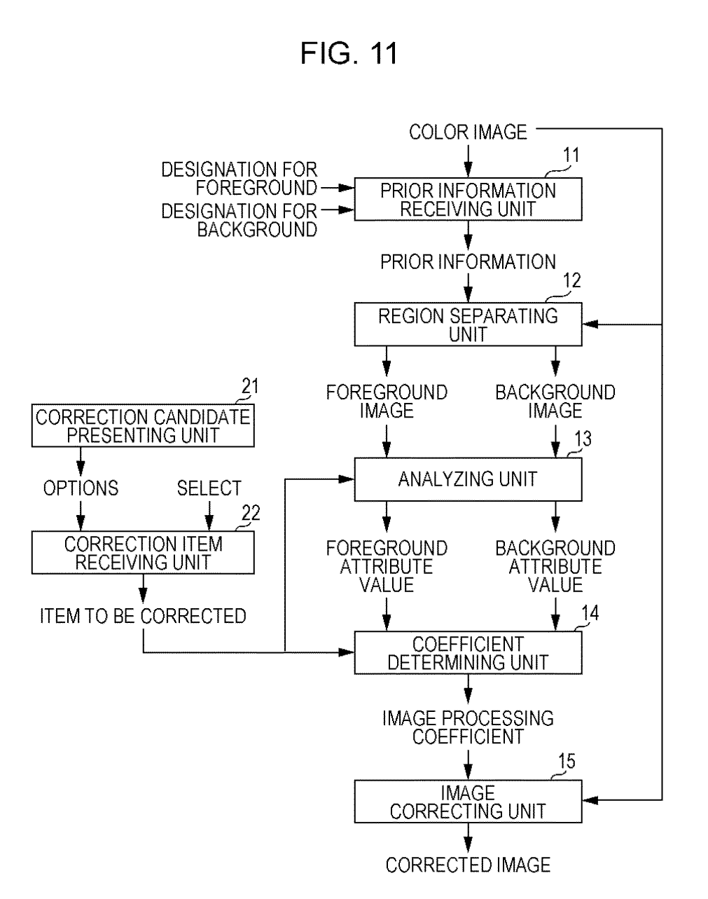

FIG. 11 is a block diagram illustrating a variation of the first exemplary embodiment of the invention. Referring to FIG. 11, a correction candidate presenting unit 21 and a correction item receiving unit 22 are provided. In this variation, the configuration in which an image is analyzed and corrected in such a manner that a user's intention is reflected more correctly than the configuration described above is provided. Points different from the explanation provided above will be mainly explained.

The correction candidate presenting unit 21 presents to a user options corresponding to an item to be corrected. For example, the type of correction represented by a word or a phrase representing correction processing, such as color correction or frequency correction, may be presented to a user, or an item to be corrected may be indirectly selected by presenting the type of content represented by a word or a phrase representing the details of an image corresponding to the details of correction. Alternatively, after presenting the type of content represented by a word or a phrase representing the details of an image, the type of correction represented by a word or a phrase representing correction processing, such as color correction or frequency correction, may be presented in accordance with the selected type of content.

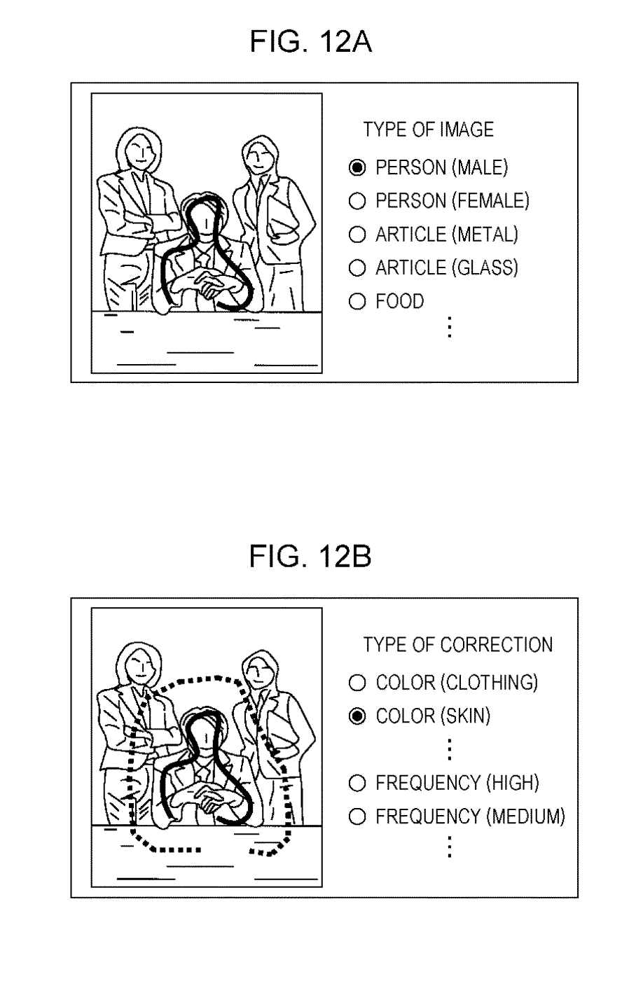

FIGS. 12A and 12B are explanatory diagrams illustrating examples of presentation of options by the correction candidate presenting unit 21. In the example illustrated in FIG. 12A, as options for the type of content, “type of image”, is presented. Items including “person (male)”, “person (female)”, “article (metal)”, “article (glass)”, and “food” are listed as options. A user may select one of the listed options for a portion of an image designated for the foreground.

In the example illustrated in FIG. 12B, options for the type of correction are presented. In this example, items including “color (clothing)”, “color (skin)”, “frequency (high)”, and “frequency (medium)” are presented as options. The user may select a desired correction item from the listed options.

Obviously, the items are not necessarily presented as illustrated in FIG. 12A or 12B. Various other items may be presented and the presentation method is not limited to the above examples. Furthermore, although an example in which options for the type of content or the type of correction are presented has been described above, options may be presented to a user in various forms. For example, as described above, the type of correction may be presented in accordance with an item selected in the presentation of the type of content.

The correction item receiving unit 22 receives a correction item in accordance with selection from options by a user, and notifies the analyzing unit 13 or both the analyzing unit 13 and the coefficient determining unit 14 of the selected item. The user may select one or more items.

The correction item receiving unit 22 may determine a correction item(s) to be received, on the basis of the selected item or the combination of the selected items. Furthermore, in the case where a selection is made from among options presented for the type of correction in accordance with an item selected for the type of content, a correction item to be received may be determined on the basis of the results of the selection for the type of correction and the selection for the type of content.

The analyzing unit 13 selects an item to be analyzed, on the basis of the correction item received by the correction item receiving unit 22, and analyzes a foreground image and a background image for the selected analysis item to acquire a foreground attribute value and a background attribute value.

For example, in the case where a user selects “person (female)” in the example illustrated in FIG. 12A, the analyzing unit 13 may define the skin color average of the foreground image that is considered to include a person as an item to be analyzed. In this case, if the background is a simple design such as a wall, since it is clear from analysis whether or not color casting occurs, a color histogram may be defined as an item to be analyzed for the background image. Furthermore, in the case where the user selects an “item (metal)”, it is presumed that the user intends to improve the quality of a portion of an article. In this case, the intensity of a frequency component for the foreground image that is considered to include an article may be selected as an item to be analyzed. Regarding the background image, in the case where the average of intensities of frequency components is higher than usual, it is considered that a noise component exists. In this case, the average of intensities of frequency components may be defined as an item to be analyzed. Obviously, various other characteristics may be analyzed.

The coefficient determining unit 14 determines an image processing coefficient for performing correction processing for the entire color image, on the basis of the relationship between a foreground attribute value and a background attribute value obtained by the analyzing unit 13. At this time, the determination may be made on the basis of a correction item received by the correction item receiving unit 22.

In the example described above, in the case where the “person (female)” is selected by the user in the example illustrated in FIG. 12A, an image processing coefficient for performing color correction for the skin color taking into consideration color casting in the background, on the basis of the skin color average and a color histogram acquired as a foreground attribute value and a background attribute value, respectively, by the analyzing unit 13. Furthermore, in the case where the “article (metal)” is selected by the user, an image processing coefficient may be determined in such a manner that the frequency band and the enhancement degree are adjusted so as not to make a noise component in the background conspicuous, on the basis of the frequency component intensity and the average frequency component intensity acquired as a foreground attribute value and a background attribute value, respectively, by the analyzing unit 13.

The image correcting unit 15 performs correction processing for a given color image on the basis of an image processing coefficient determined by the coefficient determining unit 14. In this case, correction processing is performed in such a manner that the balance between the foreground and the background is achieved. In addition, a foreground image and a background image are analyzed in accordance with an item selected by the user, and the image processing coefficient is determined in accordance with the result of the analysis. Thus, an image that reflects a user's intention is acquired.

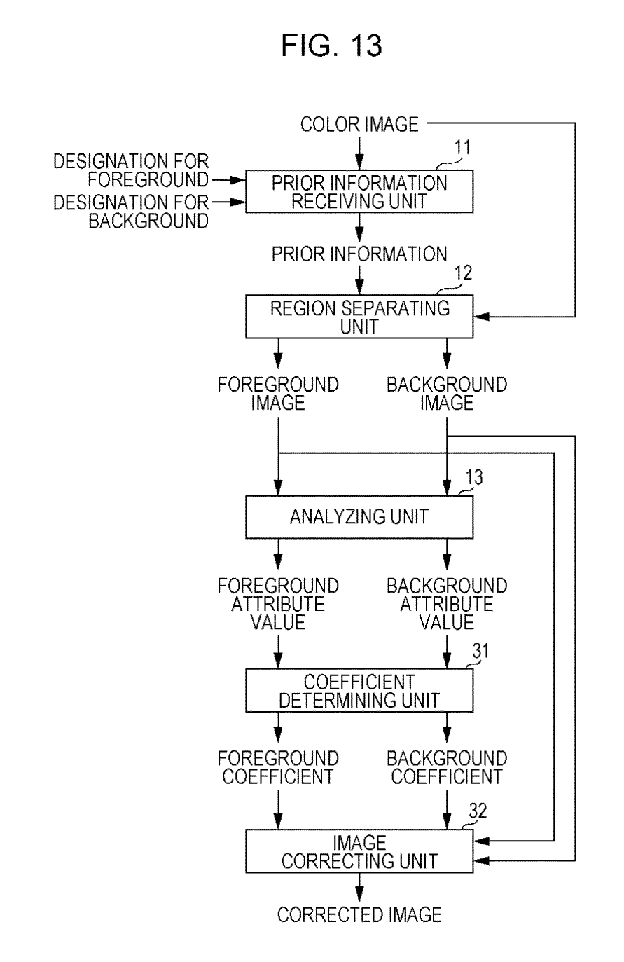

FIG. 13 is a block diagram illustrating a second exemplary embodiment of the present invention. Referring to FIG. 13, a coefficient determining unit 31 and an image correcting unit 32 are provided. In the first exemplary embodiment, the case where correction processing is uniformly performed for the entire color image has been described. In the second exemplary embodiment, the case where correction processing is individually performed for a foreground image and a background image on the basis of corresponding image processing coefficients and a composite corrected image is obtained will be explained. Since the prior information receiving unit 11, the region separating unit 12, and the analyzing unit 13 are similar to those explained in the first exemplary embodiment, explanation for those similar units will be omitted.

The coefficient determining unit 31 calculates a foreground coefficient, which is an image processing coefficient for a foreground image, on the basis of a foreground attribute value and a background attribute value acquired by the analyzing unit 13, and a background coefficient, which is an image processing coefficient for a background image, on the basis of the foreground attribute value and the background attribute value.

The image correcting unit 32 performs correction for a corresponding foreground image on the basis of a foreground coefficient determined by the coefficient determining unit 31, performs correction for a background image on the basis of a background coefficient, and combines the corrected foreground image and background image together. The correction processing for the foreground image and the background image is performed on the basis of the foreground coefficient and the background coefficient that are determined on the basis of a foreground attribute value and a background attribute value, respectively, by the coefficient determining unit 14. Thus, processing corresponding to the details of the foreground and the background is performed. As the correction processing, various types of correction processing including the processing exemplified by the image correcting unit 15 in the first exemplary embodiment of the invention may be performed.

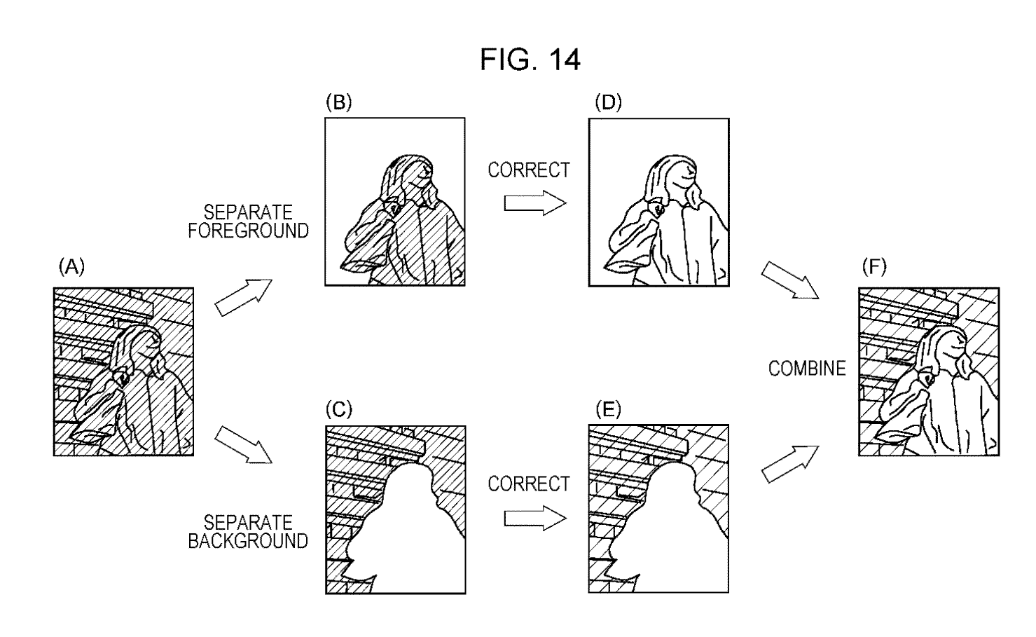

FIG. 14 is an explanatory diagram illustrating an example of processing performed in the second exemplary embodiment of the invention. FIG. 14(A) illustrates an example of a given color image, which is used in FIG. 3. In FIG. 14(A), oblique lines provided overall illustrate that color casting occurs. A user acquires prior information at the prior information receiving unit 11 by designating a portion inside a person for the foreground and designating a portion outside the person for the background, and the region separating unit 12 performs separation between a foreground image and a background image on the basis of the prior information. The foreground image and the background image that are separated from the color image illustrated in FIG. 14(A) are illustrated in FIGS. 14(B) and 14(C), respectively.

The analyzing unit 13 analyses the foreground image to acquire a foreground attribute value, and analyzes the background image to acquire a background attribute value. In the case where color casting occurs, for example, by analyzing the background image to acquire a color histogram, the occurrence of the color casting is detected. Furthermore, the foreground image includes the skin color of the person. By performing color analysis to acquire a color histogram, the skin color average is detected.

The coefficient determining unit 31 determines a foreground coefficient and a background coefficient on the basis of the foreground attribute value and the background attribute value. For example, for the foreground image, a foreground coefficient for correcting the color casting state, which is detected on the basis of the background attribute value, and the skin color is determined. Furthermore, for the background image, a background coefficient is determined in such a manner that the state of color casting is corrected to an extent not to cause the person in the foreground image to be buried in the background.

The image correcting unit 32 performs correction processing for the foreground image in accordance with the foreground coefficient determined by the coefficient determining unit 31, and performs correction processing for the background image in accordance with the background coefficient. FIG. 14(D) illustrates an example of a foreground image for which correction processing has been performed, and FIG. 14(E) illustrates an example of a background image for which correction processing has been performed. For the background image, the state in which color casting has been reduced is represented by changing in the density of oblique lines. For the foreground image, elimination of color casting is represented without oblique lines.

As described above, the corrected foreground image and background image are combined together. The composite image is illustrated in FIG. 14(F). Correction processing is performed in such a manner that color casting is reduced and a person defined as the foreground is made conspicuous.

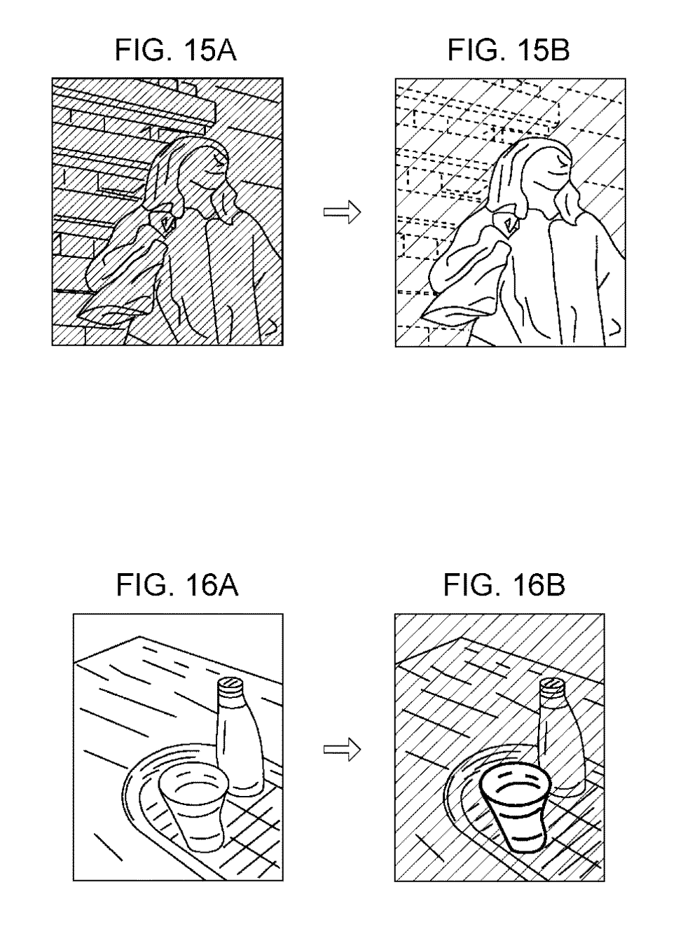

FIGS. 15A and 15B are explanatory diagrams illustrating another example of processing performed in the second exemplary embodiment of the invention. FIG. 15A illustrates an example of a given image, and FIG. 15B illustrates an example of a corrected image. In each of the examples illustrated in FIGS. 15A and 5B, correction for a skin color or the like corresponding to the background is performed for a person defined as the foreground. Furthermore, for the background, blurring processing that provides perspective (frequency processing) is performed, on the basis of the result of analysis of frequency components of a foreground image and a background image. For the convenience of illustration, blurring in the background is expressed using broken lines.

FIGS. 16A and 16B are explanatory diagrams illustrating another example of processing performed in the second exemplary embodiment of the invention. FIG. 16A illustrates an example of a given image, which is illustrated in FIG. 4. FIG. 16B illustrates an example of a corrected image. In each of the examples illustrated in FIGS. 16A and 16B, the image includes an article, and a glass portion is separated as the foreground from the original image.

By acquiring the average of high-frequency components or a frequency component histogram, as well as the color average, as a foreground attribute value and a background attribute value, the difference in the brightness between the glass and the background, the enhancement degree of the glass with respect to the background, and the like are obtained. On the basis of the foreground attribute value and the background attribute value, correction processing, such as adjustment of frequency component enhancement and brightness by changing the tone curve of the brightness, is performed for the foreground image (for the convenience of illustration, represented by thick lines), and the background image is corrected to be darker by changing the tone curve of the brightness so as to make the foreground image conspicuous (for the convenience of illustration, represented by oblique lines).

In the second exemplary embodiment, the correction candidate presenting unit 21 and the correction item receiving unit 22 explained in the variation of the first exemplary embodiment may be provided. For example, by performing correction processing while selecting the “person (female)” as the type of content in the example illustrated in FIGS. 15A and 15B or selecting the “article (glass)” as the type of content in the example illustrated in FIGS. 16A and 16B, the selection instruction is reflected in the correction processing. Thus, compared to the case where such an instruction is not issued, more accurate correction processing is performed.

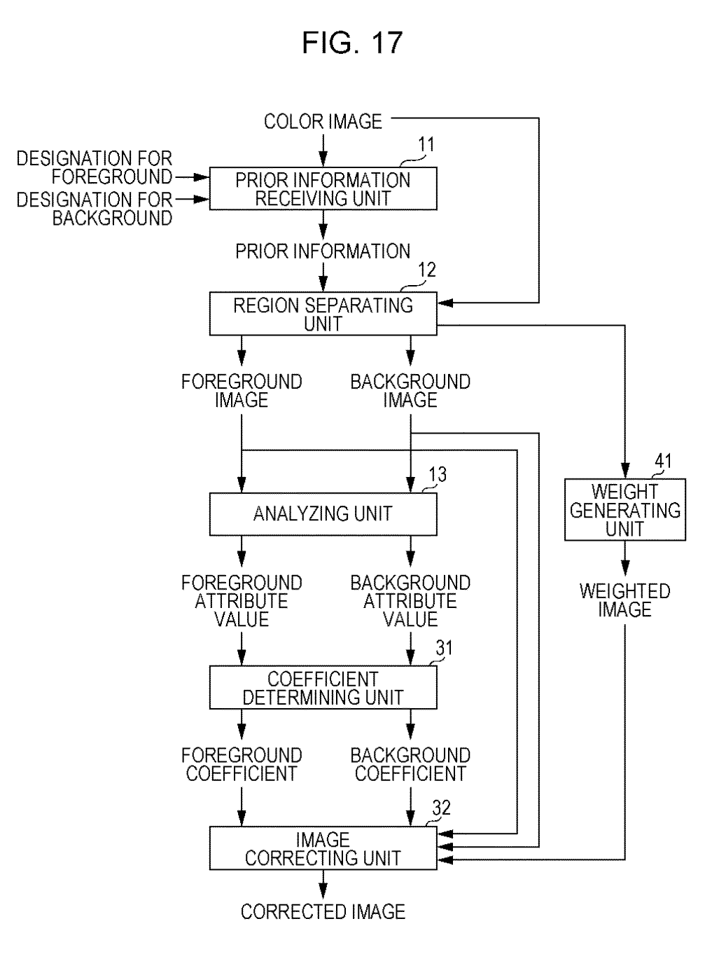

FIG. 17 is a block diagram illustrating a first variation of the second exemplary embodiment of the invention. Referring to FIG. 17, a weight generating unit 41 is provided. In the case where correction processing is individually performed for a foreground image and a background image in the second exemplary embodiment described above, a problem may occur in the continuity at the boundary between the foreground and the background in a composite image. In the first variation, combining is performed taking into consideration the continuity at the boundary between the foreground and the background. Points different from the second exemplary embodiment described above will be mainly explained below.

The weight generating unit 41 generates a weighted image for controlling weights for a foreground image and a background image corrected by the image correcting unit 32 when the corrected foreground image and the corrected background image are combined together. Any weighted image may be generated as long as the weighted image does not cause trouble in the continuity at the boundary at the time of combining. For example, an image obtained by blurring a region image representing a region separated as a foreground image or a background image from the original image may be used as a weighted image.

The image correcting unit 32 combines a corrected foreground image and a corrected background image on the basis of the weighted image generated by the weight generating unit 41. At the time of combining, the corrected foreground image and the corrected background image may be combined together at a combining ratio, which is based on the value of the weighted image.

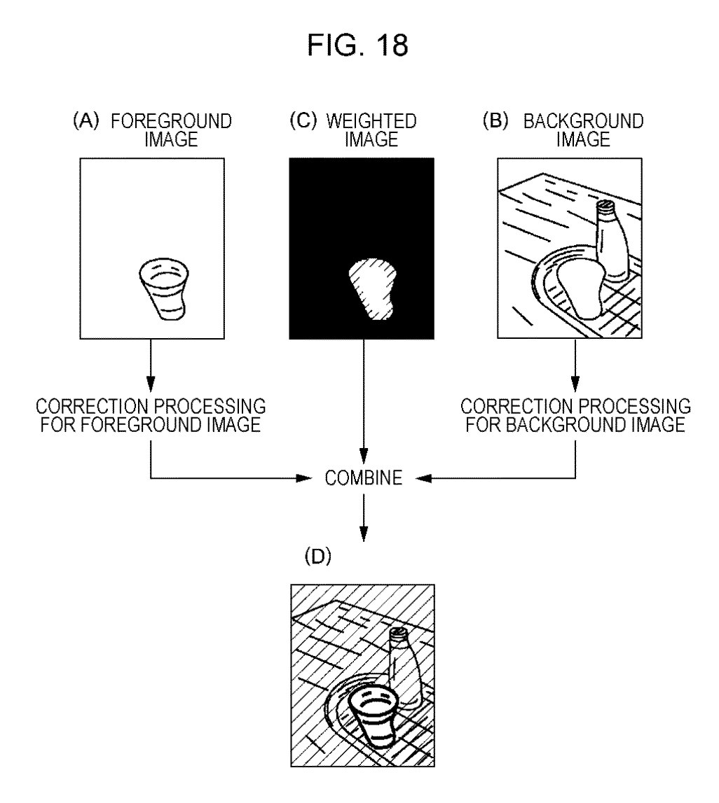

FIG. 18 is an explanatory diagram illustrating an example of processing performed by an image correcting unit using a weighted image. In this example, the color image illustrated in FIG. 4 is separated into a foreground image and a background image, as illustrated in FIGS. 6A and 6B, and the foreground image and the background image are illustrated in FIGS. 18(A) and 18(B), respectively. Correction processing is performed for the foreground image illustrated in FIG. 18(A) in accordance with a foreground coefficient. Correction processing is performed for the background image illustrated in FIG. 18(B) in accordance with a background coefficient.

In the case where separation between the foreground image illustrated in FIG. 18(A) and the background image illustrated in FIG. 18(B) is performed, a region image representing whether the image is defined as the foreground image or the background image is generated. Here, a region separated as the foreground image is represented as a white region, and the value is set to, for example, 1. A region separated as the background image is represented as a black region, and the value is set to, for example, 0. Obviously, the value of each of the foreground and the background is not necessarily set to the value mentioned above.

As described above, information including “1” and “0” is regarded as an image, and blurring processing is performed. As blurring processing, for example, the Gaussian function represented as Equation 2 may be used, or other well-known methods, such as generation by reducing and enlarging an image, may be used. FIG. 18(C) illustrates an example of a weighted image obtained by performing blurring processing for a region image. For the convenience of illustration, a blurred portion is provided with oblique lines. Such a weighted image may be generated by the weight generating unit 41.

The image correcting unit 32 combines a corrected foreground image and a corrected foreground image together using the weighted image generated by the weight generating unit 41 as described above. For example, in the case where the (i,j)th pixel value of the weighted image is represented as wᵢⱼ, the (i,j)th pixel value of the foreground image is represented as Pᵢⱼ, the (i,j)th pixel value of the background image is represented as Qᵢⱼ, and the (i,j)th pixel value of the composite image is represented as Rᵢⱼ, weighted combining may be performed in accordance with Equation 3:

Rᵢⱼ=wᵢⱼ·Pᵢⱼ+(1−wᵢⱼ)·Qᵢⱼ (3),

where the pixel value wᵢⱼ of the weighted image serving as a weight may be normalized within a range from 0 to 1 inclusive. Furthermore, for a color image, combining may be performed for each color component. For example, for an image in an RGB color space, combining processing may be performed for each of R, G, and B color components. FIG. 18(D) illustrates an example of a composite image.

In the first variation of the second exemplary embodiment, the correction candidate presenting unit 21 and the correction item receiving unit 22 explained in the variation of the first exemplary embodiment may be provided. By analyzing a foreground image and a background image in accordance with a correction item received by the correction item receiving unit 22, determining a foreground coefficient and a background coefficient, and performing correction processing for the foreground image and the background image, the corrected foreground image and the corrected background image may be combined together in accordance with a weighted image.

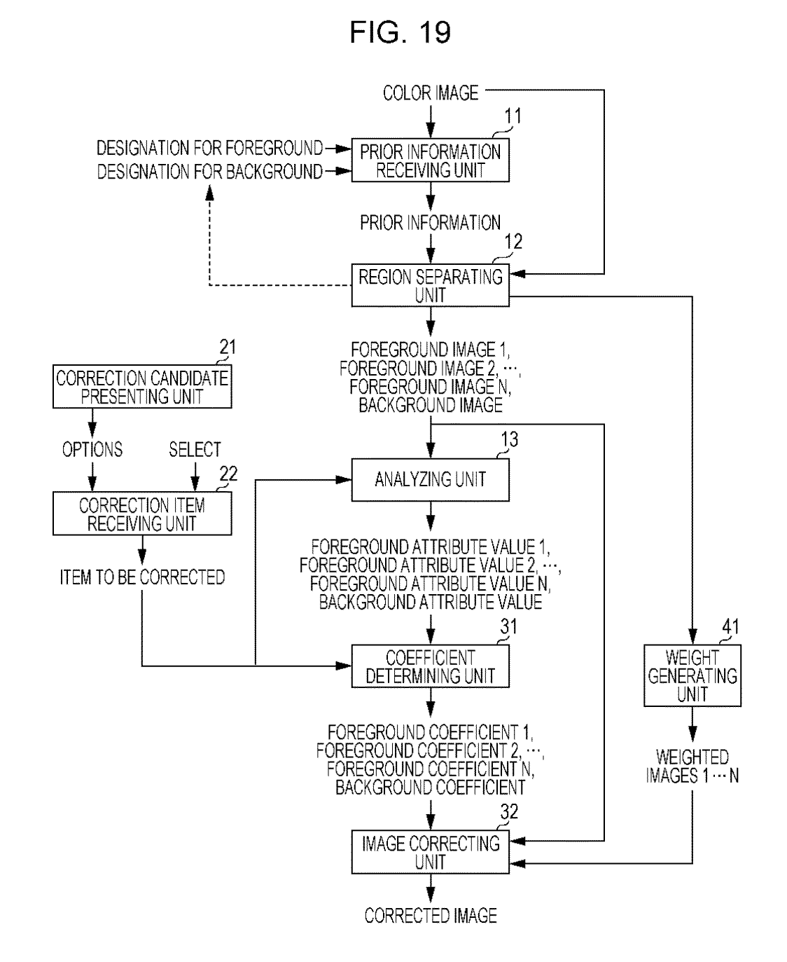

FIG. 19 is a block diagram illustrating a second variation of the second exemplary embodiment of the invention. Although the case where a single foreground image exists has been explained in the examples described above, the case where plural foreground images are separated from a given color image will be explained in the second variation. Points different from the configuration of each of the examples described above will be mainly explained below.

In the example of FIG. 19, a configuration in which the correction candidate presenting unit 21 and the correction item receiving unit 22 explained in the variation of the first exemplary embodiment and the weight generating unit 41 explained in the first variation of the second exemplary embodiment are provided is illustrated. However, the above-mentioned configuration is not necessarily provided. A configuration including neither the correction candidate presenting unit 21 nor the correction item receiving unit 22, a configuration not including the weight generating unit 41 is not provided, a configuration including none of the correction candidate presenting unit 21, the correction item receiving unit 22, and the weight generating unit 41 may be provided.

In the second variation of the second exemplary embodiment, the region separating unit 12 separates a given color image into plural foreground images and one background image. In the second variation, the color image is separated into N foreground images and a background image, that is, a foreground image 1, a foreground image 2, . . . , a foreground image N, and a background image. The analyzing unit 13 performs analysis for the foreground image 1, the foreground image 2, . . . , the foreground image N, and the background image, and acquires a foreground attribute value 1, a foreground attribute value 2, . . . , a foreground attribute value N, . . . , and a background attribute value. The coefficient determining unit 31 determines coefficients of correction processing to be performed for the foreground images and the background image on the basis of the foreground attribute values and the background attribute value. In the second variation, a foreground coefficient 1, a foreground coefficient 2, . . . , a foreground coefficient N, and a background coefficient are determined. In contrast, the weight generating unit 41 generates a weighted image 1, a weighted image 2, . . . , and a weighted image N on the basis of information on regions obtained by separation among the foreground images and the background image. By performing correction processing for the foreground images in accordance with the corresponding foreground coefficients and performing correction processing for the background image in accordance with the background coefficient, the image correcting unit 32 may combine the corrected foreground images and the corrected background image together in accordance with the weighted images to acquire a processed image.

First, a well-known separation method may be used for processing by the region separating unit 12 for separating plural foreground images from an image. For example, plural foreground images may be obtained by performing processing for separating a foreground image and a background image from the original image explained in the first exemplary embodiment plural times. A region that is not defined as a foreground image may be separated as a background image.

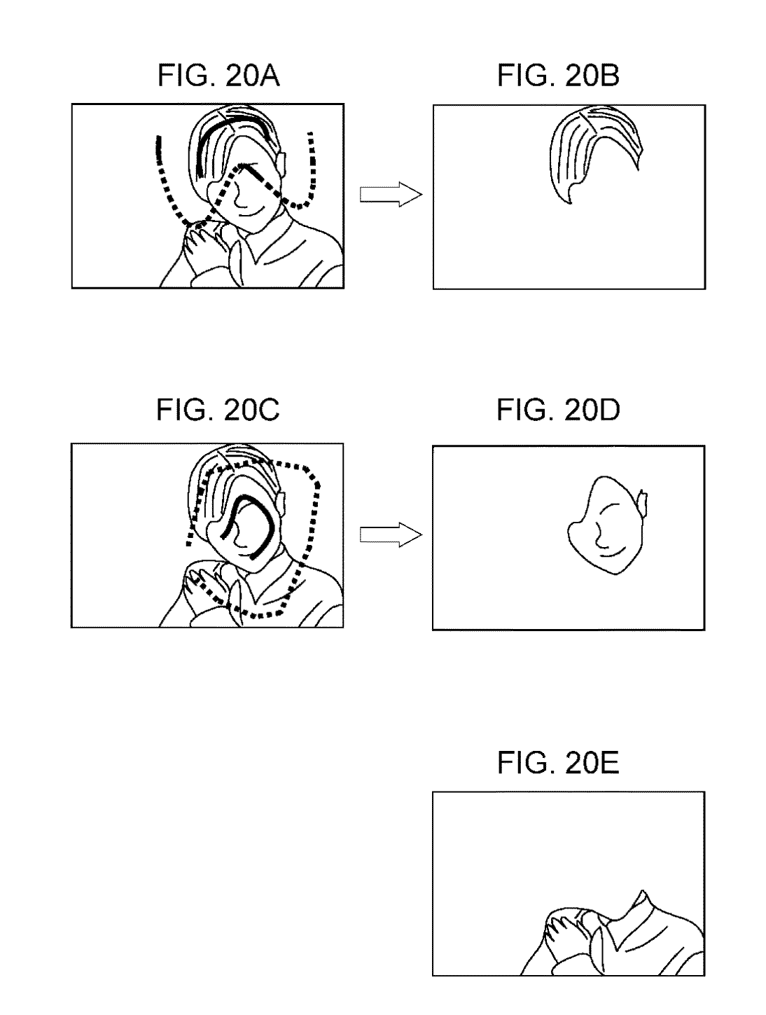

FIGS. 20A, 20B, 20C, 20D, and 20E are explanatory diagrams illustrating an example of separation processing performed plural times. In this example, the case where the above-described separation method using graph linkage is performed plural times will be described. Referring to FIG. 20A, as prior information, a portion inside the hair of a person is designated for the foreground, and a portion outside the hair is designated for the background. FIG. 20B illustrates an example of a foreground image separated from the original image by the region separating unit 12 in accordance with the prior information. The region of the hair of the person is separated as a foreground image.

Referring to FIG. 20C, as prior information, a portion inside the face of a person is designated for the foreground, and a portion outside the face is designated for the background. FIG. 20D illustrates an example of a foreground image separated from the original image by the region separating unit 12 in accordance with the prior information. The region of the face of the person is separated as a foreground image.

As described above, in this example, by performing the processing by the prior information receiving unit 11 and the region separating unit 12 twice, two foreground images, that is, a foreground image including the hair of the person and a foreground image including the face of the person, are separated from the original image. The other region may be separated as a background image, which is illustrated in FIG. 20E. Although two foreground images are separated from the original image, three or more foreground images may be separated from the original image by performing the processing three times or more. The processing may be repeated the number of times corresponding to the number of parts desired by the user.

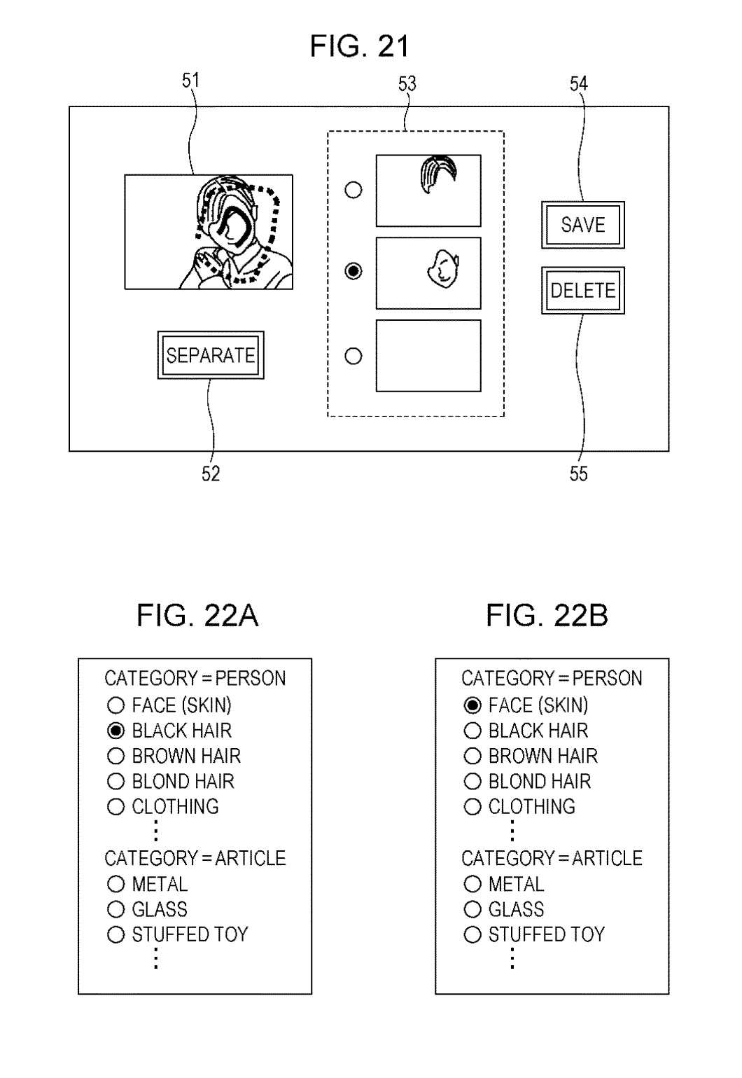

FIG. 21 is an explanatory diagram illustrating an example of a screen presented to a user in the case where plural foreground images are separated from the original image. Referring to FIG. 21, an image display part 51, a separate button 52, a foreground image presenting part 53, a save button 54, and a delete button 55 are provided. A given color image is displayed in the image display part 51. Designations for the foreground and the background may be performed for the image displayed in the image display part 51. In this example, the prior information receiving unit 11 receives the first designation for the foreground and the second designation for the background. After designating the foreground and the background, by performing an operation on the separate button 52, for example, touching the separate button 52, the region separating unit 12 separates the foreground images from the original image and adds the foreground images to the foreground image presenting part 53. In this example, the hair and the face of the person illustrated in FIG. 20 are designated for the foreground, and corresponding images are separated as foreground images from the original image. When an unnecessary separated foreground image exists since a designated foreground image is incorrect or becomes unnecessary or a user desires to designate a different region, for example, by touching the delete button 55, the foreground image is deleted from the foreground image presenting part 53.

After separation into foreground images is completed, an operation for the save button 54, such as, for example, touching on the save button 54, is performed. By operating the save button 54, a region not separated into foreground images is defined as a background image, and the background image as well as the plural foreground images are transmitted to the analyzing unit 13. Obviously, the screen illustrated in the example of FIG. 21 is not necessarily provided. Various screen configurations and display using various operation methods may be adopted.

FIGS. 22A and 22B are explanatory diagrams illustrating an example of options presented by the correction candidate presenting unit in the second variation of the second exemplary embodiment of the present invention. Processing by the correction candidate presenting unit 21 for presenting options to a user and processing by the correction item receiving unit 22 for receiving a correction item selected from the options are performed for plural foreground images. In the example illustrated in FIGS. 22A and 22B, the face (skin), the color of hair, clothing, and the like of a person, and metal, glass, a stuffed toy, and the like as articles are provided as options for the type of content. Since plural foreground images may be separated from the original image, detailed options are provided compared to, for example, the example illustrated in FIGS. 12A and 12B. In the examples illustrated in FIGS. 20A to 20E and FIG. 21, “black hair” of the person is selected as illustrated in FIG. 22A for the foreground image defining the hair of the person, and the “face (skin)” of the person is selected as illustrated in FIG. 22B for the foreground image defining the face of the person. For example, in the case where an image includes a person and an article and the person and the article are separated from the original image as foreground images, items are selected from options for a person and options for an article. The selected items are received by the correction item receiving unit 22, and the analyzing unit 13 or both the analyzing unit 13 and the coefficient determining unit 31 are informed of corresponding correction items.

Obviously, the options illustrated in FIGS. 22A and 22B are merely examples, and various other options may be provided. Furthermore, instead of the type of content, the type of correction may be presented. Alternatively, after the type of content is selected, the type of correction corresponding to the selected type of content may be presented. Accordingly, presentation may be provided in various forms.

After separation among plural foreground images and a background image in accordance with designations from a user and selection of items to be corrected for the foreground images and the background image are completed, the analyzing unit 13 performs analysis in such a manner that attribute values selected in accordance with correction items corresponding to the foreground images are acquired. Accordingly, foreground attribute values corresponding to the foreground images are acquired. Furthermore, by performing analysis for the background image in accordance with the attribute values acquired for the foreground images, a background attribute value is acquired. In FIG. 19, the acquired attribute values are represented as the foreground attribute value 1, the foreground attribute value 2, . . . , the foreground attribute value N, and the background attribute value.

For example, in the case where the hair and face of a person are separated from the original image, as illustrated in FIGS. 20A to 20E and FIG. 21, and “black hair” is selected as the type of content for the foreground image including the hair of the person (defined as a foreground image 1) and the “face (skin)” is selected as the type of content for the foreground image including the face of the person (defined as a foreground image 2), as illustrated in FIGS. 22A and 22B, frequency analysis may be performed for the foreground image 1, while the frequency average, a frequency histogram, or the like being set as the foreground attribute value 1. In addition, color analysis may be performed for the foreground image 2, while the average skin color or the like being set as the foreground attribute value 2. Furthermore, frequency analysis and color analysis may be performed for the background image, while the attribute values corresponding to the foreground attribute value 1 and the foreground attribute value 2 being set as the background attribute value.

The foreground attribute value 1, the foreground attribute value 2, . . . , the foreground attribute value N, and the background attribute value acquired by the analyzing unit 13 are transmitted to the coefficient determining unit 31, and coefficients for correction processing corresponding to the foreground images and the background image are determined. In FIG. 19, the acquired coefficients are represented as the foreground coefficient 1, the foreground coefficient 2, . . . , the foreground coefficient N, and the background coefficient.

For example, for the foreground image 1 mentioned above, a high-frequency component enhancement coefficient may be determined on the basis of the foreground attribute value 1 and the background attribute value. For the foreground image 2, a color conversion coefficient for a target color of the skin color may be determined on the basis of the foreground attribute value 2 and the background attribute value. For the background image, a medium-low-frequency component enhancement coefficient (blur coefficient) and a color conversion coefficient may be determined on the basis of the foreground attribute value 1, the foreground attribute value 2, and the background attribute value. Furthermore, in the case where the occurrence of color casting is predicted on the basis of the background attribute value, coefficients for which correction for the color casting is taken into consideration may be determined as the foreground coefficient 1 and the foreground coefficient 2. In this example, the case of an image including a person has been explained. However, for an image including an article, for example, a high-frequency component enhancement coefficient is determined for a foreground image including an article made of metal, or a medium-frequency component enhancement coefficient providing soft feeling may be determined for a foreground image including a stuffed toy.

The weight generating unit 41 generates weighted images corresponding to the foreground images. The weighted images may be generated as described in the first variation. For example, weighted images may be generated by applying blurring filtering for region information, as an image, generated when the foreground images are separated from the original image.

The image correcting unit 32 performs correction processing for the foreground images and the background image in accordance with corresponding coefficients, and performs combining with the background image at an allocation ratio corresponding to the values of the weighted images.

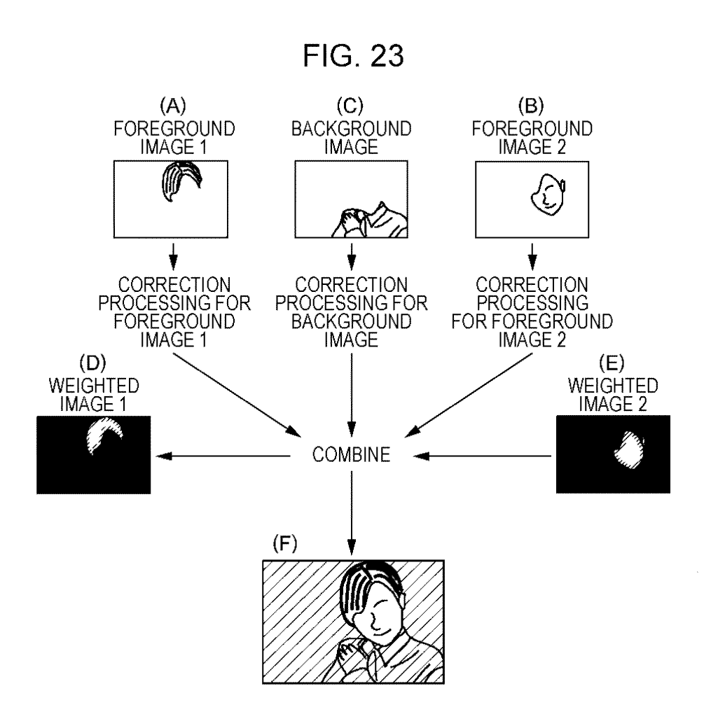

FIG. 23 is an explanatory diagram illustrating an example of processing performed by the image correcting unit 32 in the second variation of the second exemplary embodiment of the invention. FIG. 23(A) illustrates the foreground image 1, FIG. 23(B) illustrates the foreground image 2, and FIG. 23(C) illustrates the background image. The foreground image 1 illustrated in FIG. 23(A) is subjected to correction processing in accordance with the foreground coefficient 1. The foreground image 2 illustrated in FIG. 23(B) is subjected to correction processing in accordance with the foreground coefficient 2. The background image illustrated in FIG. 23(C) is subjected to correction processing in accordance with the background coefficient.

Furthermore, a weighted image 1 generated by the weight generating unit 41 in accordance with the foreground image 1 is illustrated in FIG. 23(D), and a weighted image 2 generated by the weight generating unit 41 in accordance with the foreground image 2 is illustrated in FIG. 23E.

The foreground image 1 and the foreground image 2 that have been subjected to correction processing are combined with the background image using the weighted image 1 and the weighted image 2. The combining processing may be performed in accordance with Equation 4:

Rᵢⱼ=w1ᵢⱼ·P1ᵢⱼ+w2ᵢⱼ·P2ᵢⱼ+(Σₖ₌₁²wₖₘₐₓ−w1ᵢⱼ−w2ᵢⱼ)·Qᵢⱼ (4),

where, for example, the (i,j)th pixel value of the weighted image 1 is represented as w1ᵢⱼ, the (i,j)th pixel value of the weighted image 2 is represented as w2ᵢⱼ, the (i,j)th pixel value of the foreground image 1 is represented as P1ᵢⱼ, the (i,j)th pixel value of the foreground image 2 is represented as P2ᵢⱼ, the (i,j)th pixel value of the background image is represented as Qᵢⱼ, and the (i,j)th pixel value of the composite image is represented as Rᵢⱼ. In Equation 4, “Σₖ₌₁²wₖₘₐₓ” represents the maximum value of a weighted image k. For example, in the case where normalization within a range from 0 to 1 inclusive is performed, the maximum value is 1. In the case where two foreground images exist, equation “Σₖ₌₁²wₖₘₐₓ=2” is obtained. By performing weighted combining as described above, an image including portions for which corresponding correction processing has been performed is acquired. Obviously, the method using Equation 4 is not necessarily used as a combining method. Any method may be used as long as combining is performed while allocating pixel values using weighted images. Furthermore, without providing the weight generating unit 41 described above, that is, without using a weighted image, combining may be performed on the basis of, for example, a function given in advance, or combining may be directly performed. Accordingly, a combining method may be selected from various methods.

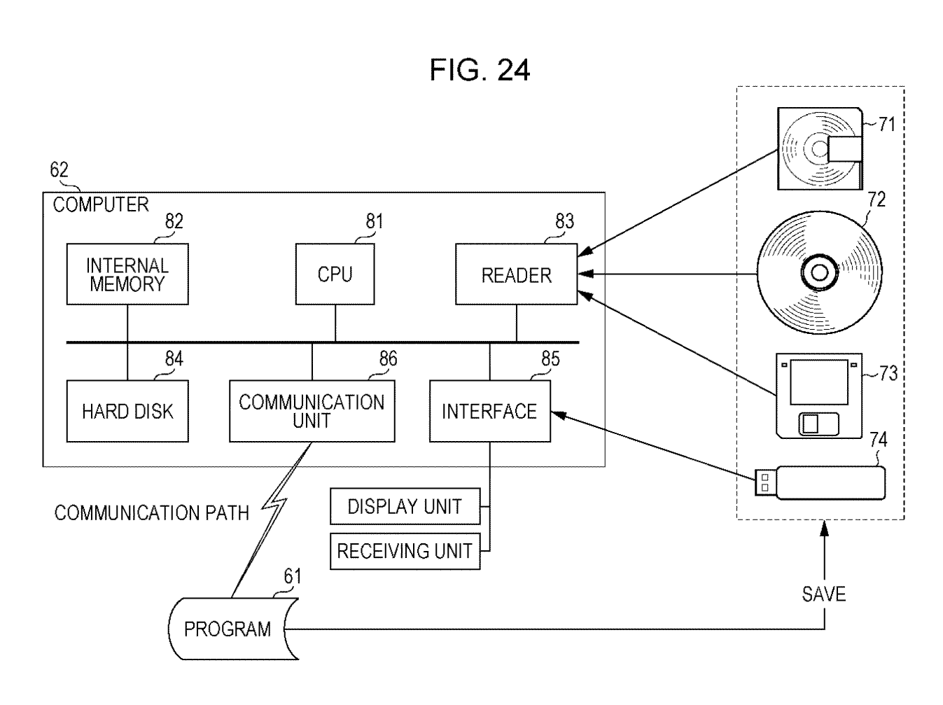

FIG. 24 is an explanatory diagram illustrating an example of a computer program and a storage medium and a computer in which the computer program is stored in the case where functions explained in the exemplary embodiments and the variations of the present invention are implemented by the computer program. Referring to FIG. 24, a program 61, a computer 62, a magneto-optical disk 71, an optical disk 72, a magnetic disk 73, a memory 74, a central processing unit (CPU) 81, an internal memory 82, a reader 83, a hard disk 84, an interface 85, and a communication unit 86 are provided.

All or some of the functions of the units explained in the exemplary embodiments and the variations of the present invention may be implemented by the program 61 executed by the computer. In this case, the program 61, data used by the program 61, and the like may be stored in a storage medium that is read by the computer. The storage medium is a medium for causing a change state of energy of magnetism, light, electricity, and the like, in accordance with the description of a program for the reader 83 included in the hardware resources of the computer and transmitting the description of the program to the reader 83 in the form of a signal corresponding to the change state. For example, the storage medium may be the magneto-optical disk 71, the optical disk 72 (including a compact disc (CD), a digital versatile disc (DVD), etc.), the magnetic disk 73, or the memory 74 (including an IC card, a memory card, a flash memory, etc.). Obviously, the storage medium is not necessarily of a portable type.

By storing the program 61 into the storage medium, inserting the storage medium into, for example, the reader 83 or the interface 85 of the computer 62, reading the program 61 from the computer, storing the read program 61 into the internal memory 82 or the hard disk 84 (including a magnetic disk or a silicon disk), and executing the program 61 by the CPU 81, all or some of the functions explained in the exemplary embodiments and the variations of the present invention may be implemented. Alternatively, all or some of the functions explained in the exemplary embodiments and the variation of the present invention may be implemented by transferring the program 61 to the computer 62 through a communication path, receiving the program 61 at the communication unit 86 of the computer 62, storing the received program 61 into the internal memory 82 or the hard disk 84, and executing the program 61 by the CPU 81.

Various devices may be connected to the computer 62 via the interface 85. For example, a display unit that displays information may be connected so that an image may be presented for designating prior information or options for correction candidates may be presented. Furthermore, receiving unit that receives information from a user may be connected to the computer 62 so that the user is able to designate a foreground and a background and select an item from options. Obviously, a different device may be connected. A single computer does not necessarily operate in the individual configurations. Processing may be performed by a different computer in accordance with the processing stage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a separating unit that separates a color image into a foreground image and a background image;
an analyzing unit that analyzes the foreground image and the background image to acquire a foreground attribute value and a background attribute value;
a determining unit that determines an image processing coefficient, based on the foreground attribute value and the background attribute value; and
an image correcting unit that corrects the color image, in accordance with the image processing coefficient.

2. An image processing apparatus comprising:
a separating unit that separates a color image into one or more foreground images and a background image;
an analyzing unit that analyzes the one or more foreground images and the background image to acquire one or more foreground attribute values and a background attribute value;
a determining unit that determines, in accordance with the one or more foreground attribute values and the background attribute value, foreground coefficients, which are image processing coefficients corresponding to the one or more foreground images, and a background coefficient, which is an image processing coefficient corresponding to the background image; and
an image correcting unit that corrects the one or more foreground images in accordance with the one or more corresponding foreground coefficients, corrects the background image in accordance with the background coefficient, and combines the corrected one or more foreground images with the corrected background image.

3. The image processing apparatus according to claim 2,
wherein in a case where the separating unit performs processing for separating the color image into a foreground and a background a plurality of times, images separated as the foreground from the color image are defined as the foreground images, and a region that is not separated as the plurality of foreground images from the color image is separated as the background image from the color image.

4. The image processing apparatus according to claim 2, further comprising:
a weight generating unit that generates weighted images for controlling weights to be applied to the one or more foreground images and the background image that have been corrected by the image correcting unit when the corrected one or more foreground images and the corrected background image are combined together,
wherein the image correcting unit combines the corrected one or more foreground images and the corrected background image together using the weighted images.

5. The image processing apparatus according to claim 4,
wherein the weight generating unit generates the weighted images by performing blurring processing for a region image representing a region separated as the one or more foreground images or the background image from the color image, and
wherein the image correcting unit combines the corrected one or more foreground images and the corrected background image together while referring to values of the weighted images as values representing the ratios of the combining.

6. The image processing apparatus according to claim 1, further comprising:
a prior information receiving unit that receives prior information for designating a foreground and a background of the color image,
wherein the separating unit generates graph link information by performing graph linkage of pixels, based on the color image and the prior information, and separates the color image into the foreground and the background in accordance with the graph link information and the color image.

7. The image processing apparatus according to claim 6,
wherein the prior information receiving unit receives a designation for the foreground or the background by a finger or a pointing device, in the form of a collection of dots or lines.

8. The image processing apparatus according to claim 1, further comprising:
a correction candidate presenting unit that presents options corresponding to items to be corrected; and
a correction item receiving unit that receives a correction item in accordance with a selection from the options by a user,
wherein the analyzing unit selects an item to be analyzed, in accordance with the correction item received by the correction item receiving unit, and analyzes the foreground image and the background image in accordance with analysis items corresponding to the foreground image and the background image to acquire the foreground attribute value and the background attribute value.

9. The image processing apparatus according to claim 8,
wherein the correction candidate presenting unit performs at least one of content type presentation represented by a word or a phrase representing the content of an image and correction type presentation represented by a word or a phrase representing correction processing including at least one of color correction and frequency correction.

10. The image processing apparatus according to claim 8,
wherein the correction candidate presenting unit performs content type presentation represented by a word or a phrase representing the content of an image, and then performs, in accordance with the selected content type, correction type presentation represented by a word or a phrase representing correction processing including at least one of color correction and frequency correction.

11. The image processing apparatus according to claim 8,
wherein the correction item receiving unit receives the correction item in accordance with an item or a combination of a plurality of items selected by the user from the options presented by the correction candidate presenting unit.

12. The image processing apparatus according to claim 8,
wherein the determining unit determines the image processing coefficient, based on the correction item received by the correction item receiving unit.

13. The image processing apparatus according to claim 1,
wherein the analyzing unit analyzes at least one of an average of color pixels, a variance of color pixels, a histogram of color pixels, an average of image frequencies, a variance of image frequencies, and a histogram of image frequencies.

14. The image processing apparatus according to claim 1,
wherein the image correcting unit performs correction processing including at least one of color correction and frequency correction.

15. An image processing method comprising:
separating a color image into a foreground image and a background image;
analyzing the foreground image and the background image to acquire a foreground attribute value and a background attribute value;
determining an image processing coefficient, based on the foreground attribute value and the background attribute value; and
correcting the color image, in accordance with the image processing coefficient.

16. A computer readable medium storing a program causing a computer to execute a process for image processing, the process comprising:
separating a color image into a foreground image and a background image;
analyzing the foreground image and the background image to acquire a foreground attribute value and a background attribute value;
determining an image processing coefficient, based on the foreground attribute value and the background attribute value; and
correcting the color image, in accordance with the image processing coefficient.
